(19) United States
(12) Patent Application Publication
(10) Pub. No.: US 2002/0070983 A1
(43) Pub. Date: Jun. 13, 2002

(54) Automated wafer handling with graphic user interface

(76) Inventors: Thomas A. Kozub, Stockton, NJ (US); Chen Chan Hsueh, Somerset, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/997,940

(22) Filed: Nov. 29, 2001

Related U.S. Application Data
(60) Provisional application No. 60/251,766, filed on Dec. 7, 2000.

(51) Int. Cl. G09G 5/00

(52) U.S. Cl. 345/846

(57) ABSTRACT

A graphic user interface controls a wafer transfer system to transfer unprocessed wafers from a wafer cassette to a wafer carrier and processed wafers from a wafer carrier to a wafer cassette. The invention includes a processor, a display device and data entry means cooperating to provide a graphical user interface for use in performing automatic wafer transfer.

### CROSS-REFERENCE TO RELATED APPLICATIONS

This application for patent is related to and claims the benefit of Provisional Application Serial No. 60/251,766 filed on Dec. 7, 2000, the entire specification of which is incorporated herein by reference.

### BACKGROUND OF THE INVENTION

The present invention relates to a control system for controlling equipment that automatically transfers a bare semiconductor substrate or wafer from a storage repository to a wafer carrier and, after processing, from the wafer carrier to a wafer storage repository. The wafer control system utilizes a graphic user interface for the control and display of wafer status, machine motion and wafer placement to minimize manual handling and wafer contamination.

Silicon wafer production typically includes the steps of crystal growing, shaping, slicing, lapping, etching and polishing. Afterwards, for the production of advanced epitaxial materials, processes such as metal organic chemical vapor deposition are used to deposit on the substrate semiconductor materials such as gallium, arsenide, indium phosphate, germanium, and others.

Each processing step the wafer undertakes involves cleaning the substrate. During this continual cycle of cleaning and process application, care must be taken to make sure contaminants are not introduced onto the substrate. In the past, between processing steps, wafers were handled manually, moved on conveyors or stored in repositories such as cassettes that store a plurality of wafers. During this time of the semiconductor industry, motion control technology was expensive compared to what it costs today. To employ motion control equipment equated into small economies of scale and large non-recurring development costs.

As wafer geometries became smaller and contamination became more of an issue, it was realized that by eliminating manual handling, device and wafer yield could be improved. Early automation systems relied on steppermotor-driven conveyor belts and cassette elevators to minimize manual handling. These early attempts helped to reduce breakage, but did not eliminate particle contamination. Throughput was not as important as yield improvement, so there was little economic incentive to automate.

Due to smaller wafer substrates emerging as the substrate of choice, a change in wafer handling was mandatory. Driven by the increased number of circuits desired on a substrate, tighter cleanliness and throughput requirements demanded robotic technology, eliminating conveyors and cassette elevators.

Today, most substrate wafer handling systems use modern three-axis, polar-coordinate robotic arms to move wafers. Robotics used in conjunction with modern motion control components, namely micro-processor based controllers, improves product throughput and reliability. Additionally, standards in the industry led to uniform size wafer cassettes and other processing equipment.

Most processing equipment manufacturers build their own wafer handling systems since each model typically has to be adaptable to many different wafer and cassette sizes. In one robotic wafer handling layout, the wafer handling system is completely surrounded by a minienvironment. The concept of using a minienvironment isolates the wafer handling process from the other substrate processing equipment.

However, many of the control interfaces for wafer transfer systems are unique applications regarding the transfer from a wafer cassette to a wafer carrier and back. There exists a need for a wafer transfer control interface that allows a user to intuitively and efficiently transfer wafers.

### SUMMARY OF THE INVENTION

One aspect of the present invention is directed to a graphic user interface for controlling a wafer transfer system to transfer unprocessed wafers from a wafer cassette to a wafer carrier and processed wafers from a wafer carrier to a wafer cassette. This aspect of the invention includes a processor, a display device and data entry means cooperating to provide a graphical user interface for use in performing automatic wafer transfer. The processor controls the displaying of a general screen, including user selectable onscreen buttons and animated control graphics configured to allow a user to graphically select and transfer one or more wafers from a cassette to the carrier whereby the graphical representation causes the physical transfer of the selected wafers.

Another aspect of the present invention provides a wafer transfer controller for a wafer transfer system comprising a display for displaying graphical user interface elements relating to physical elements of the wafer transfer system and an interface for enabling a user to select the graphical interface elements to initiate a physical wafer transfer between a wafer storage area and a processing carrier.

### BRIEF DESCRIPTION OF THE DRAWINGS

FIG. 1 is a plan view of a multiple chamber semiconductor wafer processing system.

FIG. 2 is a system block diagram of the controller of the wafer transfer system shown in FIG. 1.

FIG. 3 is an illustration of a wafer transfer system graphic user interface screen prior to wafer cassette loading.

FIG. 4 is an illustration of a wafer transfer system graphic user interface screen after wafer cassettes have been loaded and inventoried.

FIG. 5 is an illustration of a wafer transfer system graphic user interface screen displaying a help menu with a color code legend.

FIG. 6 is an illustration of a wafer transfer system graphic user interface screen after unprocessed wafers have been transferred to a wafer carrier for processing.

FIGS. 7a and 7b are schematic diagrams, primarily in block form, of user input/control action routines using the graphic user interface to perform the transfer of unprocessed wafers from a cassette to a carrier.

FIGS. 8a and 8b are schematic diagrams, primarily in block form, of user input/control action routines using the graphic user interface to perform the transfer of processed wafers from a carrier to a cassette.

### DETAILED DESCRIPTION

The embodiments will be described with reference to the drawing figures where like numerals represent like elements throughout.

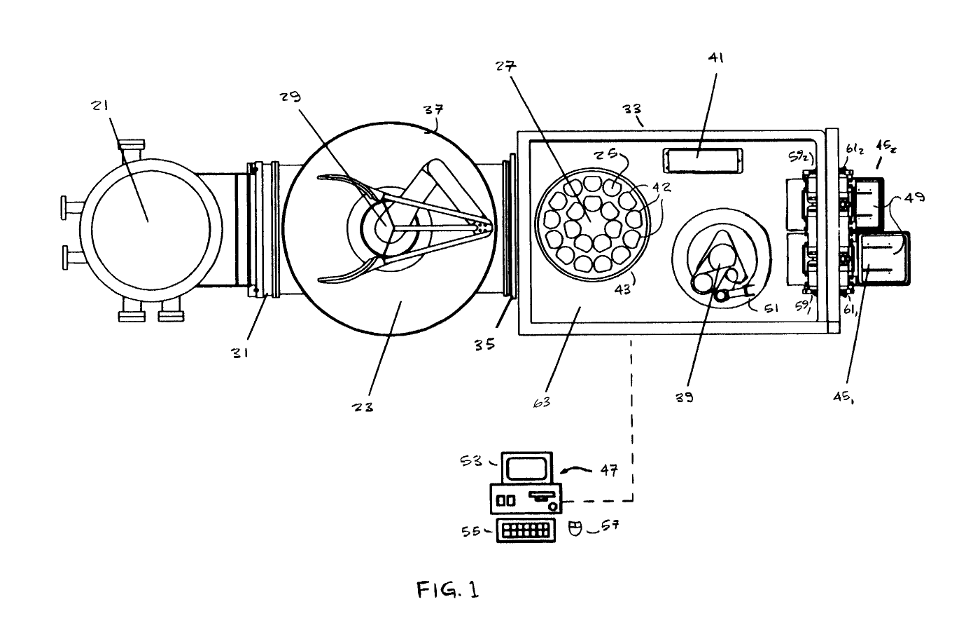

Shown in FIG. 1 is a plan view of a multiple chamber semiconductor wafer processing system that can be used with the present invention. The processing system comprises a growth chamber 21 where chemical vapor deposition takes place and a load lock chamber 23. The load lock chamber 23 allows for unprocessed and processed wafers 25 on wafer carriers 27 to be moved in and out of the growth chamber 21 by a load lock chamber robotic arm 29. A gate valve 31 provides environmental isolation between the growth chamber 21 and the load lock chamber 23. Located adjacent to the load lock chamber 23 is a preferred embodiment of the wafer transfer system 33. A second gate valve 35 provides isolation between the load lock chamber 23 and wafer transfer system 33. Each chamber of the processing system is adapted to operate under its own controlled environment, either at positive or negative pressures, or purged with a gas such as nitrogen.

Located within the load lock chamber 23 are at least two temporary storage trays 37 suitable for placing a wafer carrier in or on. The wafer carrier 27 shown in this embodiment is circular. However, one skilled in this art would appreciate that a wafer carrier may be of other configurations. The storage trays allow for the storage of wafer carriers 27 in the load lock chamber 23. The load lock chamber robotic arm 29 can unload a processed wafer carrier 27 from the growth chamber 21, place the processed wafer carrier 27 on one tray 37, and load an unprocessed wafer carrier 27 previously stored in the load lock chamber 23 into the growth chamber 21, with all operations performed in isolation. The operation of the growth chamber 21 and the load lock chamber 23 are preferably computer controlled.

The wafer transfer system 33 is a minienvironment that includes a transfer robotic arm 39, a wafer prealigner 41, a rotary carrier table including a pin lift 43, a plurality of wafer cassette antechambers 45₁, 45₂, an atmospheric control system (not shown) and a control system with a graphic user interface residing within a computer control system 47. The wafer robotic arm 39 can move in any of the three orthogonal axes with a span capable of reaching all wafer locations in an antechamber 45₁, 45₂ cassette 49 or on a wafer carrier 27. The arm 39 further includes a lifting fork with a vacuum effector 51 to apply a negative pressure to the underside of a wafer when in motion to temporarily affix the wafer 25 to the robotic arm 39. The atmospheric control minimizes airborne particles within the wafer transfer system 33 by providing a controlled environment that is purged using a gas when a transfer operation is in progress.

The computer control system 47 includes a graphic user interface displayed on a monitor or display 53, one or more data entry devices such as a keyboard 55, touch screen, and a pointing device 57 such as a mouse, light pen, touch surface or the like. The graphic user interface accepts inputs received from the user and provides graphical user control for the entire wafer transfer system 33. A control interlock is provided to couple the wafer transfer system 33 to the control system of the load lock chamber 23.

As shown in FIG. 1, each wafer transfer system 33 antechamber 45₁, 45₂ comprises an inner 59₁, 59₂ and outer 61₁, 61₂ isolation door and a wafer cassette receptacle. Both doors are interlocked exclusively with one another such that only one door can be opened at a time during normal operation, to isolate the wafer transfer chamber 63 from a respective antechamber 45₁, 45₂ when changing wafer cassettes 49. Two antechambers 45₁, 45₂ are shown in this embodiment of the wafer transfer system 33, however other embodiments may comprise more than two antechambers.

The antechambers 45₁, 45₂ allow users to replace wafer cassettes 49 containing either processed wafers with cassettes of unprocessed wafers or other combinations of wafers in a cassette 49 while maintaining a controlled environment within the wafer transfer chamber 63. As described above, each antechamber 45₁, 45₂ is capable of being purged and pressurized to prevent contamination of the wafer transfer chamber 63.

The wafer robot 39 is used to transfer wafers 25 between a wafer cassette 49, or other wafer repository, and the wafer carrier 27. When transferring unprocessed wafers 25 to the wafer carrier 27, the wafer robot 39 retrieves a predetermined wafer 25 from a cassette 49 by aligning the arm fork with the respective cassette slot, extending the arm into the slot under the wafer, raising the arm to lift the wafer 25 and applying a negative pressure on the wafer with the effector 51. The arm 39 is retracted, removing the wafer 25 from the cassette 49 slot. The wafer 25 is then moved to the prealigner 41.

The prealigner 41 uses an optical sensor to locate an index feature on an unprocessed wafer 25 to ensure that it is properly oriented when placed on the wafer carrier 27. After prealignment, the wafer robot 39 moves the wafer 25 to the wafer carrier 27.

The wafer carrier 27 comprises a plurality of wafer pockets 42 sized in matched correspondence with the wafer 25 diameters being processed. Each wafer pocket 42 has a ledge at the bottom such that the periphery of a wafer 25 will rest on the ledge and the wafer 25 will not fall through. The complete top surface of the wafer 25 and majority of the bottom surface are exposed to the environment. Since the wafer robotic arm 39 uses a forked, platform effector 51, the robotic arm 39 positions wafers by placing them in a location, removing the negative pressure, and then lowering the effector 51 onto a surface.

To facilitate the action of the robotic arm 39 effector 51 with that of a wafer carrier pocket 42, the wafer carrier 27 rests upon a rotary table having an integral pin lift 43 whereby a plurality of pins extend up through corresponding holes in the ledge surfaces in each wafer pocket 42 to a uniform height when the carrier 27 is receiving a wafer 25. The wafer robotic arm 39 locates a wafer 25 above a desired pocket 42 during a transfer to the carrier 27. The pin lift is raised through the respective wafer pocket 42 effectively forming a receiving platform for the wafer 25 to rest on. After the negative pressure is removed from the effector 51, the wafer 25 is lowered onto the pins. The wafer robotic arm 39 retracts and the pin lift descends, lowering the wafer 25 into the desired wafer pocket 42, registering the index mark with the pocket. This operation is performed for each wafer 25 to be transferred. To remove a wafer 25 from a carrier 27, the reverse operation is performed.

After a desired number of wafers 25 have been transferred onto the wafer carrier 27, the wafer transfer operation is complete. A pressure differential interlock between the load lock chamber 23 and transfer system chamber 63 must be met prior to the isolation gate valve 35 opening. The load lock chamber robotic arm 29 removes the carrier 27 from the wafer transfer chamber 63, and places a carrier containing processed wafers (if applicable) onto the pin lift table 43. The transfer of processed wafers from a carrier 27 to a cassette 49 is the reverse of the above described operation, except that the serial transfer of processed wafers to a cassette does not require indexing by the prealigner 41.

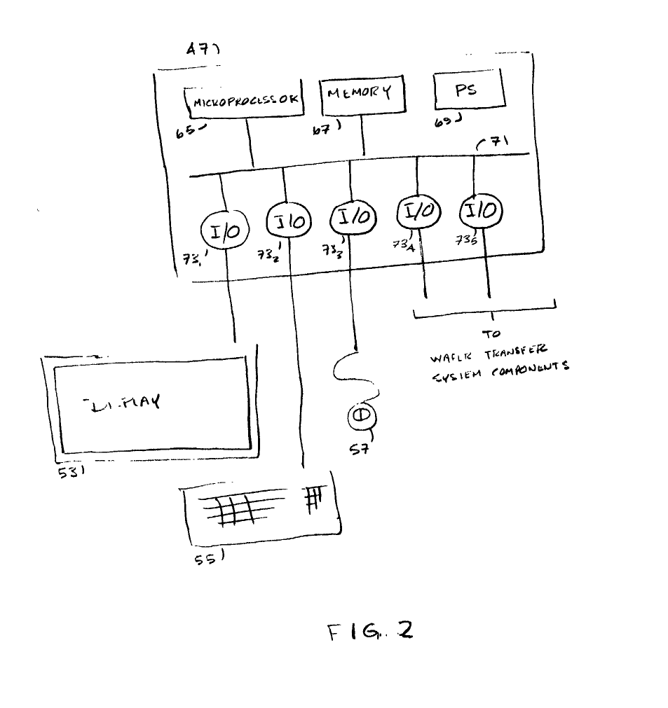

The computer control system 47 controls the operation of the wafer transfer system 33, preferably in real-time. As shown in FIG. 2, the computer control system 47 includes a microprocessor 65, a memory 67 for storing the control routines and logic, and support circuits such as a power supply 69. A communication bus 71 allows communication between the microprocessor 65 and memory 67, and with input/output (I/O) devices 73₁, 73₂, 73₃ . . . 73ₙ. The computer control system 47 is coupled to I/O peripherals such as the keyboard 55, pointing device 57, and display 53, and other devices such as a hard drive, a disk drive, or other storage media (not shown) for storing process data and operating parameters. Other connections to the communication bus 71 may include serial or parallel bus interfaces and modems. The computer control system 47 is also coupled to all control devices of the wafer transfer system 33 such as the actuators for the antechamber inner and outer doors 59, 61, robotic arm 39, prealigner 41, table with pin lift 43, ancillary limit switches, purge system, etc., through the I/O interfaces 73ₙ. The computer control system 47 may be any general purpose computer that may be programmed to perform the transport routines that the wafer transfer system 33 performs.

The transport routines that control the functionality of the wafer transfer system 33 and generate the graphic user interface are preferably software stored in memory 67 and are executed by the microprocessor 65. The wafer transport routines or logic are used to perform all operations related to unloading unprocessed wafers 25 from a cassette 49, transferring the unloaded wafers to the prealigner 71, transferring the wafers 25 to the table with pin lift 43 for placement on the wafer carrier 27 and the reverse operations. The wafer transfer software is an integrated set of automation software that views, stores, controls, analyzes and manages the information from the wafer transfer system. The software generates the display screens and shows process information in real-time. The software is preferably operationally compatible with personal computer operating systems such as a MAC OS®, Linux®, Microsoft Windows® or like operating environments.

The display 53 serves to display the graphic user interface to the user. System configuration and editing, process monitoring and the like are performed at the display 53. The user can input commands or data by using the keyboard 55 or pointing device 57.

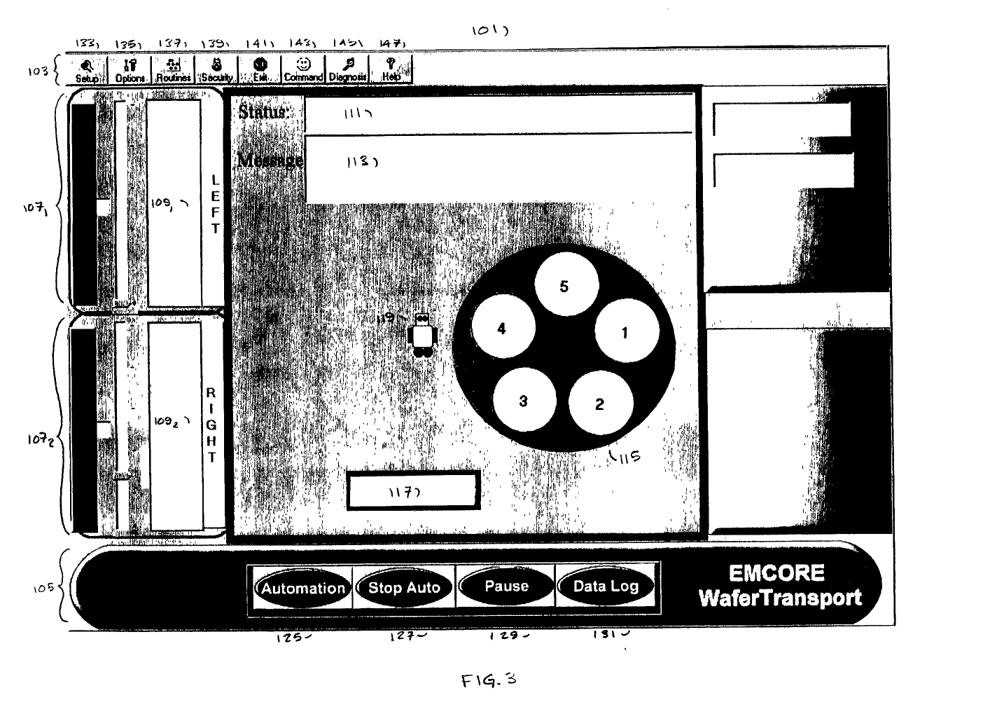

The operation and functionality of the graphic user interface screens will be described with reference to FIGS. 3 to 8. One skilled in this art appreciates that a graphic user interface or GUI, includes graphical elements representing physical elements such as windows, pull-down menus, buttons, scroll bars, icon images, the mouse pointer, sound, motion video, virtual reality and the like. Metaphors for objects existing in real life such as desk tops, a view through a window, or a representation of the physical components that comprise a mechanical or electrical system are also graphic user interface elements.

Shown in FIG. 3 is an example of a preferred graphic user interface 101 that is generated when the wafer transfer system 33 software is executed. The interface 101 displays the control and indicator functions necessary for a user to interact with the wafer transfer system 33. From the interface 101, the user selects a particular wafer 25 for carrier 27 loading (processing) and selects a particular cassette 49 and slot location for carrier 27 unloading. All user operations are performed from the screen representations presented on the display 53.

As shown, the operator interface 101 contains a static portion containing a tool bar 103 and a control bar 105. The tool bar 103 and control bar frame a dynamic area comprising animated antechamber graphics 107₁, 107₂, wafer cassette graphic locations 109₁, 109₂, transfer system status 111 and messages 113 boxes, and a graphical representation of the physical wafer transfer system components that include the wafer carrier 115, the wafer prealigner 117 and the wafer transfer robot 119.

The tool bar 103 comprises on-screen, iconic pushbuttons that access setup and maintenance menus. The setup and maintenance functions are restricted depending upon user login levels or password protection. The status box 111 displays command status messages in accordance with the preprogrammed logic. The message box 113 displays operator logs relating to system messages and annunciates alarm conditions. The messages 113 also provide status of the commands that were initiated by the user such as wafer load status, cassette scan status, door status, and others.

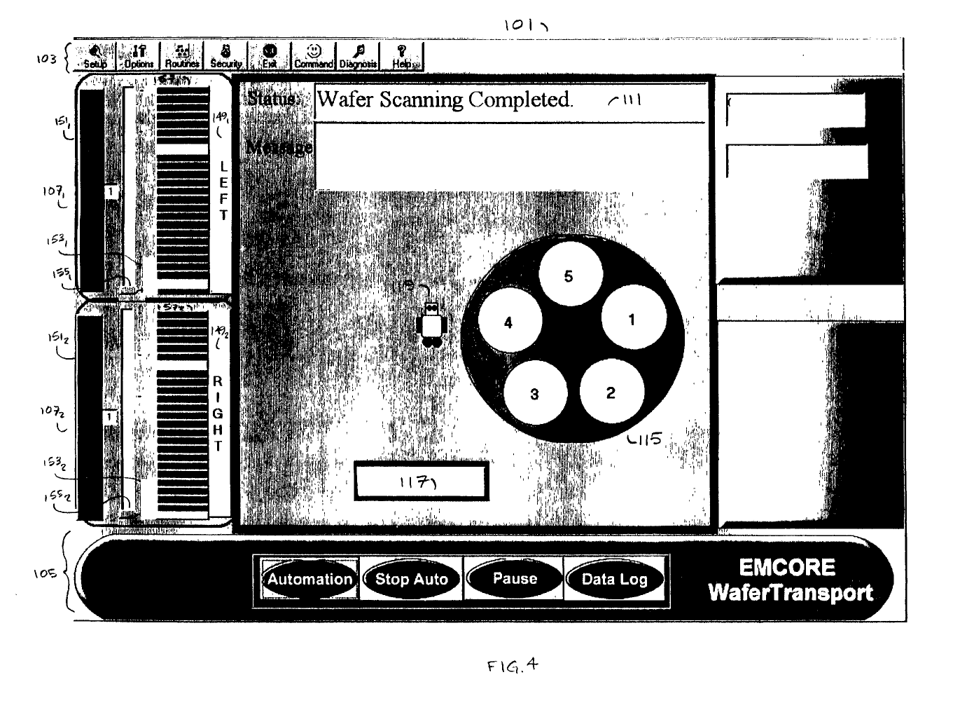

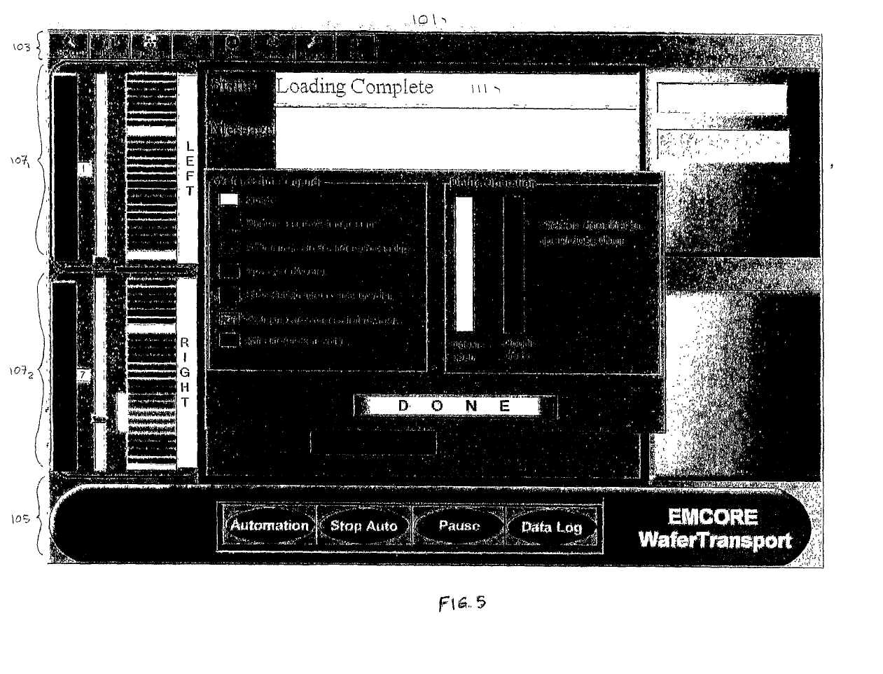

Shown in FIG. 4, the antechamber 107₁, 107₂ graphics provide indication of the wafer cassette capacity and wafer status. Each cassette antechamber graphic 107₁, 107₂ provides user interactive control and indication for outer door open/close 151₁, 151₂ and inner door open/closed 149₁, 149₂. Each cassette graphic location 109₁, 109₂ provides color code indication of cassette slot status 157₁, 157₂ an active wafer group bar graphic 153₁, 153₂ to indicate a predetermined group of wafers and an active wafer slot graphic 155₁, 155₂ with digital indicator to indicate the individual wafer slot selected by the user. As shown in FIG. 5, wafer cassette status includes wafer process status (processed/unprocessed), cassette slot status (loaded/empty), if a wafer is cross-slotted (misaligned), if a wafer resides next to a cross-slotted wafer, and others.

Referring back to FIG. 3, the wafer transport robot graphic 119 is an animated display dynamically changing location as a wafer transfer takes place. The prealigner graphic 117 shows relative position within the physical layout of the wafer transfer system 33.

The control bar 105 includes on-screen pushbuttons to control general activities such as the initiation of the automated routine 125, an emergency stop 127, pause of a routine 129, and to view a data and error log 131. The wafer carrier graphic 115 shows the load status of a particular wafer carrier 27 in the wafer transfer system. In dependence upon the size of the wafers 25, different representations of the carrier graphic 115 will be displayed. If 400 millimeter wafers 25 are used, for example, a rotary carrier showing five wafers for processing will be displayed. Color coding is preferably used to indicate whether a wafer pocket 42 is vacant or occupied.

As described above, the tool bar 103 comprises iconic pushbuttons used to perform auxiliary wafer transport system 33 functions. The buttons are setup 133, option 15, routines 137, security 139, exit 141, command 143, diagnosis 145 and help 147. The setup button 133 accesses interface parameters. The option button 135 accesses the variables to adjust the antechamber purge times. The routines 137 button provides the ability to perform basic reset and homing functions for the wafer transport robot with all wafer location coordinates. The security button 139 is used to change login status. The exit button 141 is used to exit the wafer transfer software. The command button 143 provides access to the interfaces with the wafer transport robot 39. The command function 143 is used to initialize the wafer transfer robot 39 motions. The diagnosis button 145 provides explanation if in the event access the wafer transfer system 33 faults. The help button 147 provides color coding legends for the graphics and general information on the process.

The control bar 105 provides on-screen pushbuttons to pause 129 current wafer transfer robot 39 operation and to view a data log. The data log provides a listing of messages displayed in the status and message boxes and provides statistics about the number of wafers processed.

With the above descriptions, FIG. 4 shows the operator interface 101 after a cassette has been loaded in each antechamber 45₁, 45₂. The antechamber graphics 107₁, 107₂ mimic their physical counterparts and indicate status of the various antechamber components. These graphic components comprise the inner 149₁, 149₂ and outer 151₁, 151₂ door indication and control of each antechamber 45₁, 45₂, an active wafer group bar 153₁, 153₂, an active wafer slot bar 155₁, 155₂, and digital indicator, and cassette slot status 157₁, 157₂. The number of cassette slots dynamically varies in dependence upon the type of cassette employed. FIG. 4 shows each antechamber 107₁, 107₂ after each cassette has been scanned and inventoried by the wafer transfer robot 39. After a cassette has been inventoried, the condition of each wafer is represented with the color-code convention described above.

The graphical representations provide the user interface with the wafer transfer system 33. The user places the pointing device 57 over a graphic representing a physical counterpart and selects the graphic or function by clicking or clicking and holding a button on the pointing device (if the pointing device is a mouse or pressing with a finger if a touch display) such as opening or closing a door or selecting a wafer(s) for transfer. Releasing the pointing device button releases a graphical selection. Door position can be indicated by a color change or a modulating color when in travel (as shown in FIG. 5).

The active wafer group bar graphic 153₁, 153₂ indicates which group of wafers (e.g., five wafers) will be transferred. If a wafer cassette 49 has a capacity of 25, wafer groups are preprogrammed to be selected in groups corresponding to the number of wafer pockets on the carrier 27. The active wafer slot 155₁, 155₂ graphic indicates the individual wafer slot selected by the user. This graphic indicates which individual wafer 25 will be transferred. In this embodiment, the cassette slot graphic indicates 25 individual positions to provide the status on the wafers stored in a respective slot.

The wafer transfer software preferably has two login levels each having different capabilities. The operator login is the standard operator login level. The operator level permits all functionality required to load and unload wafer carriers 27 and load and unload wafer cassettes 49 from the antechambers 45₁, 45₂. From this level, only the security 139 and help 147 buttons on the tool bar are active. A supervisor login level has the same capabilities as the operator level with additional access to configuration and maintenance operations. The supervisor level accesses all tool bar buttons with the exception of the setup 133 button. The setup 133 button is only accessible by the manufacturer for equipment setup.

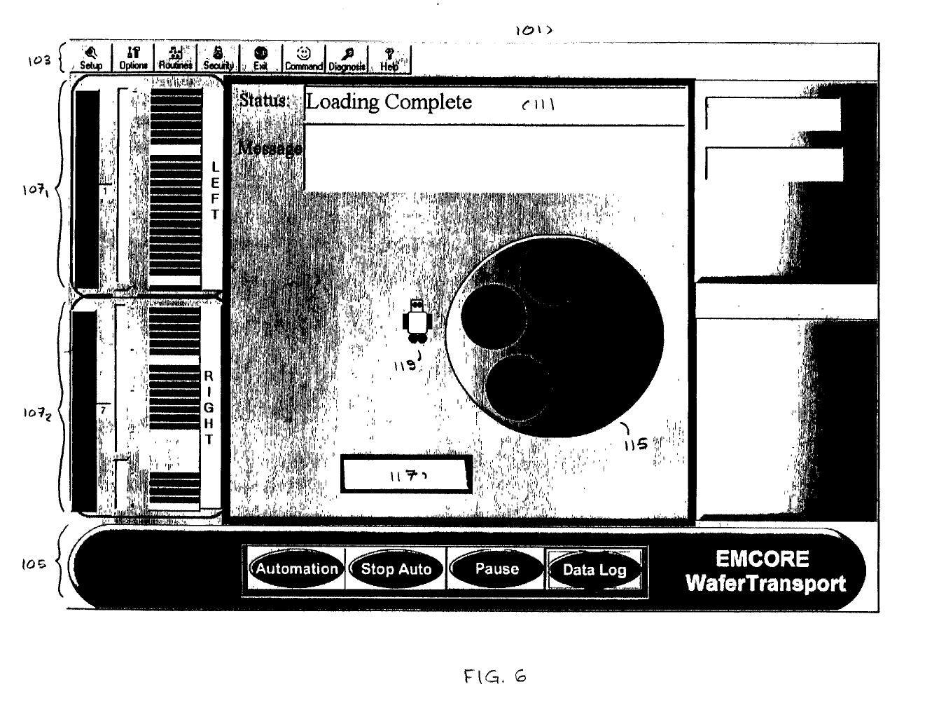

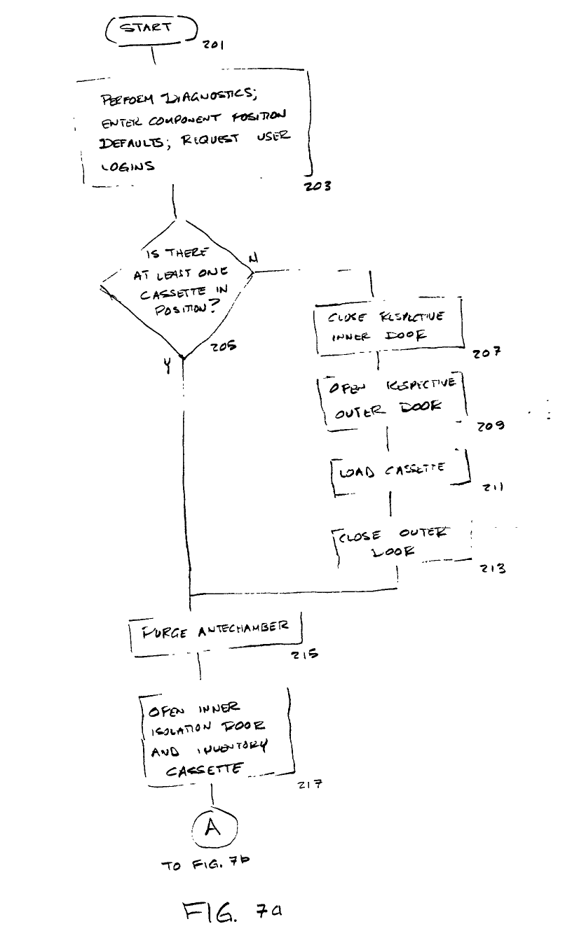

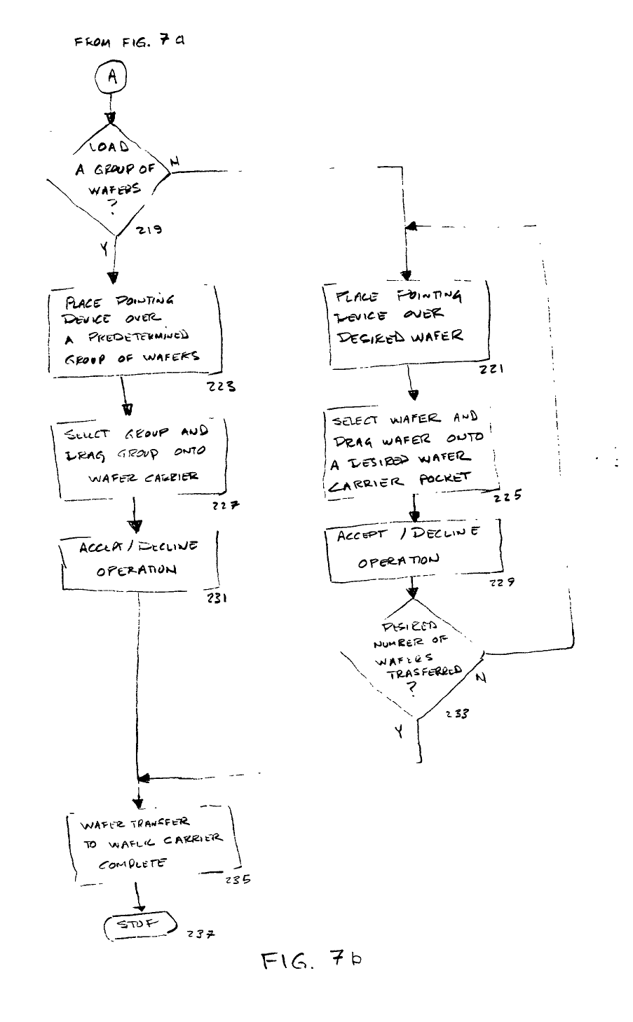

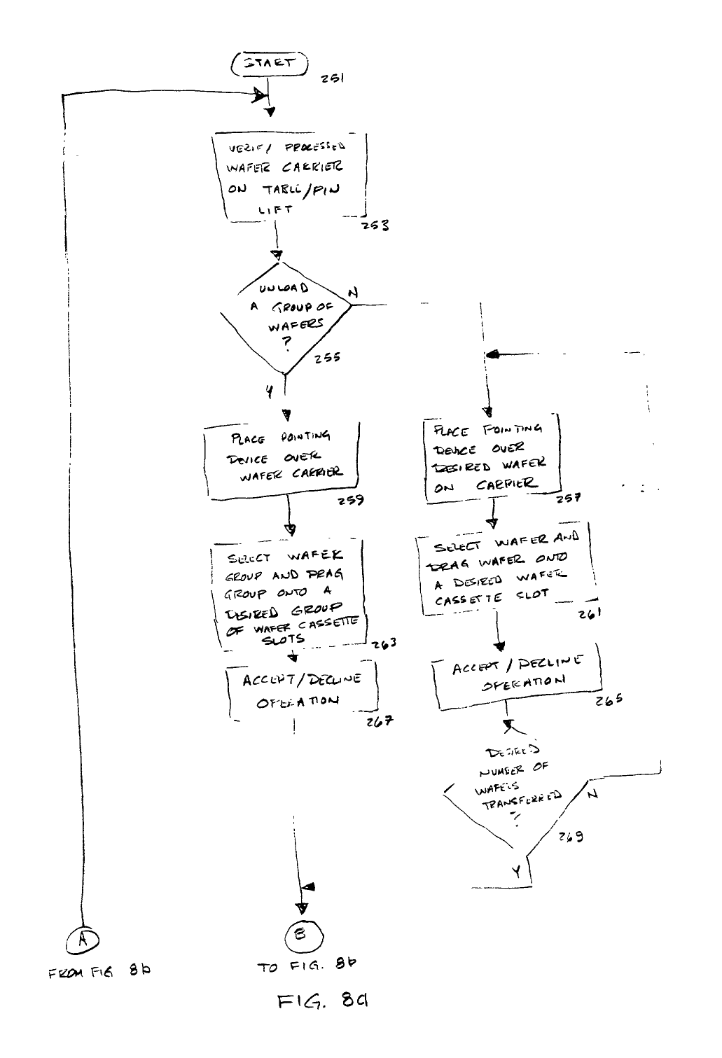

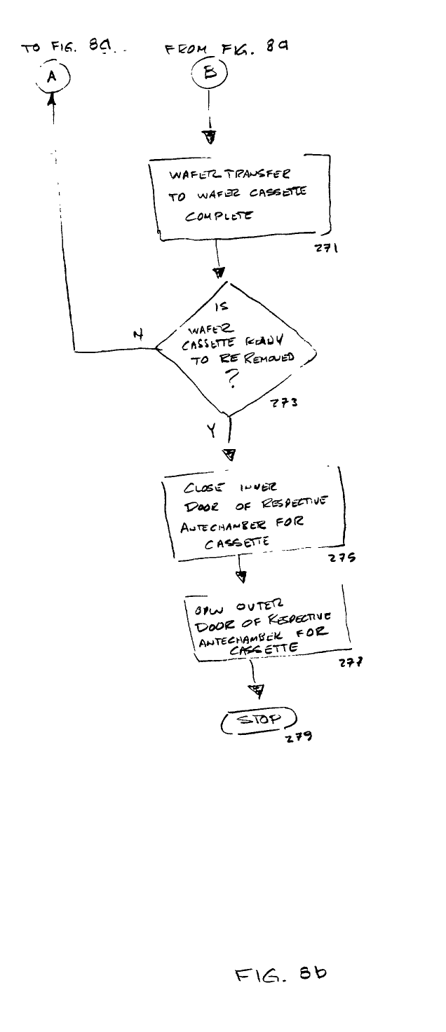

Shown in FIG. 6 is a graphic of the operator interface after a wafer carrier 27 has been completely loaded. Shown in FIGS. 7a, 7b, 8a and 8b are the user input and control actions performed using the graphical user interface 101 to transfer wafers between cassettes and carriers.

Referring now to FIGS. 7a and 7b, after a user opens the wafer transfer application (step 201), a user login is performed via the keyboard 55, followed by a self-diagnostic check (step 203) of the wafer transfer system 33. The control system acknowledges via a message whether cassettes 49 are in the antechambers 45₁, 45₂ (step 205) and requires the user to select a default position for the antechamber inner 59₁, 59₂ and outer 61₁, 61₂ doors.

If wafer cassettes 49 have not been loaded, the user verifies that the inner door 59₁, 59₂ of a desired antechamber ⁴⁵1, 45₂ is closed (step 207), and opens its respective outer door 611, 612 (step 211) from the display 53 using the pointing device 57 and inner 149₁, 149₂ and outer 151₁, 151₂ door graphics. A wafer cassette 49 with a desired number of wafers 25 is manually loaded (step 211) into the antechamber 45₁, 45₂ by the user and the outer door 611, 612 is closed (step 213) from the user interface 101. After the outer door 611, 612 is closed, the antechamber 45₁, 45₂ is automatically purged (step 215).

The user opens the inner door ⁵⁹1, 59₂ to the wafer transfer chamber 63. After the inner door 59₁, 59₂ is fully open, the wafer robotic arm 39 performs a scan of the cassette 49 to determine the inventory of the cassette 49 and status of the wafers 25 (step 217). The inventory of the cassette is then displayed 157₁, 157₂. The user must decide whether to load a single wafer from a cassette or a group of wafers from one cassette (step 219).

To load a single wafer 25 or a group of wafers 25 from the cassette 49, the user selects a desired wafer from the graphic 157₁, 157₂ (step 221) or selects a group of wafers using the active group bar graphics 155₁, 155₂ (step 223). If one wafer is selected, the user drags the selection onto a predetermined wafer carrier pocket on the carrier graphic 115 and releases the selection (step 225). If a group of wafers are selected, the group is dragged from the cassette graphic 109₁, 109₂ to the wafer carrier graphic 115 and released (step 227). After the wafers have been graphically transferred, a request to transfer is issued by the wafer transfer software. The software checks if the request is physically safe and allowed. If the operation is allowed, a message confirming the action is posted 111 and the user either accepts or cancels the operation (steps 229, 231). If accepted, the wafer robotic arm 39 performs the physical wafer transfer to the carrier 27. If the operation is not allowed, a message is posted in the message box 113 to inform the user that the requested operation is not allowed and will not be performed. As the wafer robotic arm 39 transfers the wafer(s), the robotic arm graphic 119 mimics the motion of the robot arm 39 until the transfer is completed. If a single wafer was transferred, the user inputs for transferring a single wafer are repeated (step 233) if desired.

After a wafer carrier 27 is loaded according to the user s requirements (step 235), the transfer operation is essentially complete (step 237). Since the transfer system chamber 63 is maintained at its purged and pressurized state throughout the wafer transfer process, the control system for the processing equipment ensures that there is no differential pressure across the isolation gate valve 35 prior to opening. The user opens the load lock isolation gate valve 35 to permit the load lock robotic arm 29 to remove the carrier 27 from the carrier table 43 for processing and return a carrier having processed wafers. The control actions for the processing equipment are beyond the scope of this disclosure.

To transfer processed wafers from a carrier 27 to a cassette 49 is the reverse of the above described operation. Referring to FIGS. 8a and 8b, after a carrier 27 is returned to the carrier table 43 by the load lock chamber robotic arm 29, the load lock isolation gate valve 35 is closed and processed wafer transfer can commence. If the same cassette containing the unprocessed wafers is to be used for the transfer, the user proceeds with the transfer operation. If a new cassette is to be used for receiving the processed wafers, the user performs the process of loading a cassette into a vacant antechamber 45₁, 45₂ as described above.

To unload a processed wafer carrier (step 251), the control system verifies that a processed wafer carrier 27 is present (step 253). The user must decide whether to transfer a single wafer, or all of the wafers from the carrier as a group (step 255).

To transfer a single processed wafer or a group of processed wafers from the carrier 27, the user selects a desired processed wafer 25 graphic (step 257)or selects all of the processed wafers by selecting the carrier (step 259). If one wafer 25 is selected, the user drags the selection into a predetermined cassette wafer slot and releases the selection (step 261). If a group of processed wafers are selected, the group is dragged from the carrier graphic 115 to the predetermined cassette wafer slots and released (step 263). After the processed wafers have been graphically transferred, a request to transfer is issued by the wafer transfer software. The software checks if the request is physically safe and allowed. If the operation is allowed, a message confirming the action is posted 111 and the user either accepts or cancels the operation (steps 265, 267). If accepted, the wafer robotic arm 39 performs the physical wafer transfer from the carrier 27 to the cassette. If the operation is not allowed, a message is posted in the message box 113 to inform the user that the requested operation is not allowed and will not be performed. As the wafer robotic arm 39 transfers the processed wafer(s), the display graphic of the arm 119 mimics the motion of the arm until the transfer is completed. If a single processed wafer was transferred, the user inputs for transferring a single wafer are repeated (step 269).

After all of the processed wafers have been removed from a wafer carrier 27, the transfer operation is essentially complete. The wafer carrier 27 may be loaded with unprocessed wafers.

If desired by the user (step 273), the cassette with the processed wafers may remain in the antechamber for subsequent processed wafer transfers, or be removed from the antechamber by closing the inner door of the respective antechamber (step 275), depressurizing if applicable, and opening the outer antechamber door (step 277) for manual cassette removal by the user (step 279).

Each step of transferring a wafer or a group of wafers can be performed manually using the graphic user interface as described above, or performed under complete automatic control. For automatic control, the user positions the pointing device 57 over the automation button 125 on the display and selects the operation. An automated sequence is initiated, whereby the wafer transfer system 33 software commands the robotic arm 39 to transfer a group of unprocessed wafers 25 from a cassette 49 to the carrier 27. Afterwards, the load lock gate valve 35 is opened. The software issues serial commands to transfer the loaded carrier 27 to the growth chamber 21 and initiate wafer 25 processing. After processing is completed, the loaded carrier 27 is transferred from the growth chamber 21 to the carrier table 43. The processed wafers are then transferred to a wafer cassette 49. The automated sequence repeats itself until a predefined number of unprocessed wafers have been processed. This feature eliminates user operations minimizing human error and increases throughput for mass production of wafer processing.

According to the present invention, a user may transfer a single wafer, or a plurality of wafers, between a wafer cassette and wafer carrier intuitively, obviating manual operations by the user and possible wafer contamination. The graphical user interface of the present invention minimizes the control operations that a user has to perform when transferring a wafer before and after processing.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An input control system for an automatic wafer transfer within a physical wafer processing system comprising:
a display device with a graphical user interface for displaying indicia relating to the transfer of one or more wafers to and from a wafer carrier used in the wafer processing system; and
said display device being further configured to allow a user to graphically select said indicia to direct the transfer of one or more of said wafers between a wafer cassette and wafer carrier whereby said graphical selection causes physical transfer of said selected one or more wafers.

2. The input control system of claim 1 wherein said indicia comprises graphical control elements corresponding to physical control elements whereby said graphical control elements control said physical control elements.

3. The input control system of claim 2 wherein said indicia further includes wafer graphics representative of physical wafers and a destination graphic representative of one or more physical elements for holding the wafers, and said graphical user interface allowing selection of one or more of said wafer graphics and dragging said selected wafer graphics to said destination graphic using a pointing device to effect physical transfer of said selected wafers.

4. The input control system of claim 3 wherein said destination graphic is a wafer cassette slot graphic.

5. The input control system of claim 3 wherein said destination graphic is a wafer carrier graphic.

6. The input control system of claim 3 wherein said destination graphic is a wafer pocket graphic.

7. A wafer transfer controller for a wafer transfer system, comprising:
a display for displaying graphical user interface elements corresponding to physical elements of the wafer transfer system; and
an interface for enabling a user to cause said graphical interface elements to initiate a physical wafer transfer between a wafer storage cassette and a wafer processing carrier.

8. The wafer transfer controller according to claim 7, wherein said interface allows for receiving commands from said user.

9. The wafer transfer controller according to claim 8, wherein said commands are input by said user using a pointing device.

10. The wafer transfer controller according to claim 9, wherein said user commands comprise a graphical element on said display selected with said pointing device.

11. The wafer transfer controller according to claim 10, wherein said graphical elements comprise:
at least one antechamber graphic;
at least one wafer cassette graphic, each said wafer cassette graphic including at least one wafer slot graphic;
at least one wafer graphic and
at least one wafer carrier graphic, each said wafer carrier graphic including at least one wafer pocket graphic.

12. The wafer transfer controller according to claim 11, wherein each said antechamber graphic further comprises:
an outer door graphic;
an inner door graphic;
an area for said wafer cassette graphic; and
and a wafer slot indicator graphic to indicate which wafer slot graphic is selected by said user.

13. The wafer transfer controller according to claim 12, wherein a wafer graphic is selected by said user on said display and is dragged to a destination graphic to cause said corresponding physical wafer transfer initiation.

14. The wafer transfer controller according to claim 13, wherein said destination graphic is one of said at least one wafer carrier graphic.

15. The wafer transfer controller according to claim 13, wherein said destination graphic is one of said at least one wafer pocket graphic.

16. The wafer transfer controller according to claim 13, wherein said destination graphic is one of said at least one wafer cassette slot graphic.

17. A method for a user to control the physical transfer of wafers between wafer cassettes and carriers in a wafer processing system using a graphical user interface comprising:
displaying on the graphical user interface one or more wafer graphics representative of the wafers, one or more wafer cassette graphics representative of the wafer cassettes and one or more wafer carrier graphics representative of the wafer carriers;
selecting at least one wafer graphic;
dragging said at least one selected wafer graphic to a destination graphic;
placing said at least one selected wafer graphic over a predetermined location on said destination graphic; and
releasing said selected at least one wafer graphic.

18. The method for transferring wafers according to claim 17 further comprising:
physically transferring at least one wafer corresponding to said at least one selected wafer graphic.

19. The method for transferring wafers according to claim 18 wherein selecting further comprises:
placing a pointer of a pointing device over a wafer graphic; and
acknowledging said pointing device pointer position.

20. The method for transferring wafers according to claim 19 wherein said releasing further comprises acknowledging said pointing device pointer position.

21. An input control apparatus to control wafer transfer between a wafer cassette and a wafer carrier in a wafer transfer system comprising:
a computer system including a processor, a display device, an input device and a software program operative under control of said processor, said computer and said software program being operative to create a graphical user interface for display on said display device;
said graphical user interface including graphical representations of the wafer transfer system, at least one wafer graphic, at least one wafer cassette slot graphic and at least one wafer carrier graphic; and
said input device allowing a user to graphically select said at least one wafer graphic and place said selected wafer graphic on a destination graphic whereby said graphical selection and placement causes physical transfer of a corresponding wafer to a corresponding destination of the wafer transfer system.

22. The input control system of claim 21 wherein said destination graphic is a wafer cassette slot graphic.

23. The input control system of claim 21 wherein said destination graphic is a wafer carrier graphic.

24. The input control system of claim 23 wherein said destination graphic is a wafer pocket graphic.

25. A computer usable medium having computer readable instructions stored therein for causing a processor in a computer system to generate a graphical user interface for use in the physical transfer of wafers between a wafer cassette and a wafer carrier in a wafer transfer system, the instructions comprising instructions for:
displaying on the graphical user interface one or more wafer graphics representative of the wafers, one or more wafer cassette graphics representative of the wafer cassettes and one or more wafer carrier graphics representative of the wafer carriers;
allowing user selection of at least one wafer graphic;
allowing graphical movement of at least one selected wafer to a destination graphic by dragging said at least one selected wafer graphic to a destination graphic;
allowing user placement of said at least one selected wafer graphic over a predetermined location on said destination graphic; and
allowing user confirmation of said placement by releasing said selected at least one wafer graphic.

26. The computer usable medium according to claim 25 further comprising:
allowing for a user to control the physical transfer of at least one wafer corresponding to said at least one selected wafer graphic.

27. An input control apparatus to control wafer transfer between a wafer cassette and a wafer carrier in a wafer transfer system comprising:
a computer system including a processor, a display device, an input device and a software program operative under control of said processor, said computer and said software program being operative to create a graphical user interface for display on said display device;
said graphical user interface including graphical representations of the wafer transfer system, at least one wafer graphic, at least one wafer cassette slot graphic and at least one wafer carrier graphic; and
said input device allowing a user to graphically select groups of wafer graphics and place said selected groups of wafer graphics on a destination graphic whereby said graphical selection and placement causes physical transfer of a corresponding group of wafers to a corresponding destination of the wafer transfer system.
